(19) United States
(12) Patent Application Publication
(10) Pub. No.: US 2004/0230319 A1
(43) Pub. Date: Nov. 18, 2004

(54) Microcontroller device for complex processing procedures and corresponding interrupt management process

(75) Inventors: Orazio Musumeci, Gela (IT); Santi Carlo Adamo, Gravina di Catania (IT); Martino Quattrocchi, Acireale (IT); Francesco Bombaci, Messina (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 10/783,712

(22) Filed: Feb. 20, 2004

(30) Foreign Application Priority Data
Feb. 21, 2003 (EP) 03425105.8

(51) Int. Cl. G05B 15/00

(52) U.S. Cl. 700/1

(57) ABSTRACT

A microcontroller device in which complex processing procedures to be executed iteratively are implemented in a hardware manner by finite state machines, the deice including a module for managing the processing procedures and an interrupt managing module, and a set of registers for enabling interruption of execution in the module, for managing the processing procedures and transfer of control to the interrupt manager, as well as for enabling restoration of the control to the manager of the processing procedures. The registers store information regarding the type of interrupt and the state on which it intervenes. Selection information is derived from the contents of the registers to establish whether the interrupt operates on a standard instruction or else on an iterative procedure, and in order to command operation of the control unit accordingly.

### BACKGROUND OF THE INVENTION

1. Field of the Invention

The present invention relates to techniques for implementing complex processing procedures in microcontrollers, such as procedures that require an iterative execution.

2. Description of the Related Art

In microcontroller devices in which it is necessary to execute repeatedly a set of operations, for example to execute such operations in an iterative manner, a known approach is to adopt the solution of implementing complex processing procedures in a hardware manner, in other words by implementing said processing procedures by means of purposely designed logic circuits.

In particular, it is known to use, for this purpose, a logic circuit configured as a finite state machine, comprised in the control unit of the microcontroller device.

The processing procedure is thus assigned to said finite state machine, which executes it as an atomic instruction, in other words an instruction the execution of which cannot be interrupted. The duration of such processing procedures may be hundreds of cycles of the clock signal of the microcontroller device. Deriving therefrom is the fact that, by adopting the aforesaid solution, the microcontroller device is in effect insensitive to external or internal events, such as the so-called interrupts, for an interval of time corresponding to the execution of the processing procedure.

Microcontroller devices thus suffer from a rigidity of use when they execute complex processing procedures, and this is a reason for a certain slowness in the execution of high-priority routines.

### BRIEF SUMMARY OF THE INVENTION

The disclosed embodiments of the present invention provide a solution capable of performing the functions described previously in a more flexible way so as to enable, for example, interruption of an iterative processing procedure executed by means of a finite state machine.

According to the present invention, a microcontroller device is provided having the characteristics referred to specifically in the claims that follow, including a corresponding method for interrupt control, as well as the corresponding computer program product directly loadable into the memory of a computer, such as a processor, and including software code portions that perform the method of the invention when the product is run on a computer.

In accordance with one embodiment of the invention a control unit has registers associated therewith for storage of information regarding the interrupt that has occurred, and enabling transfer of control of the procedure from the finite state machine that executes it to an interrupt managing module.

In accordance with another embodiment of the invention, a microcontroller device is provided that includes a control unit having a plurality of logic modules that include a processing module for executing processing procedures, an interrupt managing module for managing program interruptions caused by internal or external events, and an arbiter module for managing switching of the plurality of modules. The device further includes a set of interruption registers associated with the control unit for storing information regarding interrupts and for requesting arrest of the processing module for executing processing procedures at the time an interrupt is received.

In accordance with another embodiment of the invention, the set of interruption registers includes a register of the interrupts, a register containing the information regarding which interrupt has interrupted execution of the processing procedure, and a register in which there is stored the state of the module for managing the processing procedure at the time the interrupt has occurred.

In accordance with another aspect of the foregoing embodiment, the control unit is configured to write information directly in the interrupt registers and to send a selection signal containing information regarding the received interrupt.

In accordance with another embodiment of the invention, a method for managing program interrupts in a microcontroller device is provided. The method is implemented in a module for managing executive processing procedure of a control unit belonging to the microcontroller device for executing processing procedures and it provides for managing interrupts by means of an interrupt managing module. The method includes the operations of, upon occurrence of an interrupt in a state of the processing procedure, transferring control from the module for managing the executive processing procedure to the interrupt managing module; storing the information regarding the interrupt that has occurred in interrupt registers; at the end of the interrupt, transferring control to the interrupt managing module for execution of an instruction of a “return from interrupt” type; and restoring the control to the module for managing the processing procedure at the state it was at the time the interrupt occurred.

In accordance with another embodiment of the invention, a microcontroller device is provided that includes a control unit having a processing module and an interrupt managing module; a first register having an input coupled to the control unit, the first register configured to store interrupts; a second register having an input coupled to the control unit and configured to store information regarding an interrupt that has interrupted execution of a processing procedure; a third register configured to store the state of the processing module at the time the interrupt occurs, the third register having an input coupled to the control unit; and a logic gate having a first input coupled to the first register and a second input coupled to the second register and an output coupled to the control module.

In accordance with yet a further embodiment of the invention, a method for managing program interrupts in a microcontroller device is provided. The method is designed for use in a microcontroller device that includes a control unit having a processing module, an interrupt managing module, and an arbiter module, and the device further including a set of interruption registers for storing information regarding interrupts and for requesting arrest of the processing module for executing processing procedures, the control unit configured to write information directly to the interrupt registers and to send a selection signal containing information regarding an interrupt. The method includes the steps of receiving an interrupt in the control unit; upon receipt of the interrupt, transferring control from the processing module to the interrupt managing module; storing information regarding the interrupt into the set of interruption registers; processing the interrupt; and transferring control of the interrupt managing module at the end of the interrupt to the processing module at the state at which the interrupt occurred.

In accordance with yet a further embodiment of the invention, a microcontroller device is provided that includes a control unit having a processing module for executing processing procedures and having an output, an interrupt managing module having an input coupled to the output of the processing module, the interrupt managing module configured to manage program interruptions caused by at least one of internal and external events; a loading manager module for managing loading of data into the control unit, and an arithmetic-operations manager module for managing arithmetic operations, the arbiter module configured to execute the operation of downloading instructions from a memory; a first register having an input coupled to an output of the control unit, the first register configured to store interrupts; a first multiplexer coupled to an output of the first register and having an output, the first multiplexer further having a control terminal coupled to a control output of the control unit; a second register having an input coupled to an output of the control unit, the second register configured to store information regarding an interrupt that has interrupted execution of a processing procedure managed by the processing module; a second multiplexer coupled to the second register and having an output, the second multiplexer further including a control terminal coupled to the control signal output of the control unit; a third register having an input coupled to an output of the control unit, the third register configured to store the state of the processing module at the time the interrupt occurs; and a logic gate having a first input coupled to the output of the first multiplexer, a second input coupled to the output of the second multiplexer, and an output coupled to an input of the control unit, the logic gate configured to generate a return selection signal, the processing module configured to transfer control to the interrupt managing module upon receipt of an interrupt signal, the control unit configured to write information directly to the first, second, and third registers regarding the interrupt, and upon receipt of a predetermined return selection signal, to transfer control to the interrupt managing module for execution of an instruction of a return-from-interrupt type that restores control to the processing module at the state at which the processing module was in at the time the interrupt occurred.

As compared to known designs, the solution proposed herein is more flexible and reduces processing times.

### BRIEF DESCRIPTION OF THE DRAWINGS

The embodiments of the invention will now be described, purely by way of non-limiting example, with reference to the annexed drawings, in which:

FIG. 1 represents a block diagram of a control unit of the microcontroller device according to the invention; and

FIG. 2 represents a partial schematic circuit diagram of the microcontroller device according to the invention.

### DETAILED DESCRIPTION OF THE INVENTION

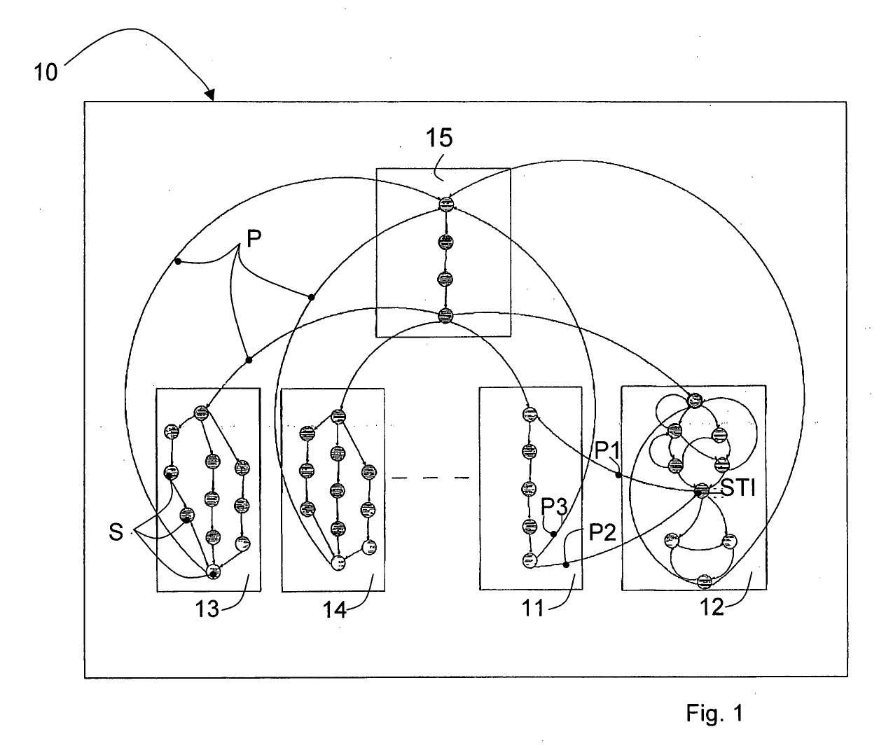

Referring to FIG. 1, shown therein is a block diagram of a control unit 10 of a modular type belonging to a microcontroller device.

The control unit 10 comprises an interrupt managing module 11, a module 12 for managing the iterative procedure, as well as modules that manage standard instructions, among which are a loading manager 13 and an arithmetic-operations manager 14. The control unit 10 further includes an arbiter module 15, which executes the operation of fetching or downloading the instructions from the memory and manages the switchings between the modules that make up the control unit 10.

The modules 11, 12, 13, 14, and 15 are all obtained using finite state machines, as may be noted in FIG. 1, where inside each module are represented logic states S and transitions P between said logic states S.

In accordance with the disclosed embodiment of the invention, upon occurrence of an interrupt, while the module 12 for managing the iterative processing procedure is operating and is in any one of its states, in particular in the state indicated by STI in FIG. 1, interruption of the processing procedure and transfer of the control directly to the interrupt managing module 11 is effectuated. When the interrupt routine is through, the control passes directly to the state, designated by STI in FIG. 1, of the module 12 for managing the iterative processing procedure, on which the interruption had occurred, and then the managing module 12 continues execution of the iterative processing procedure.

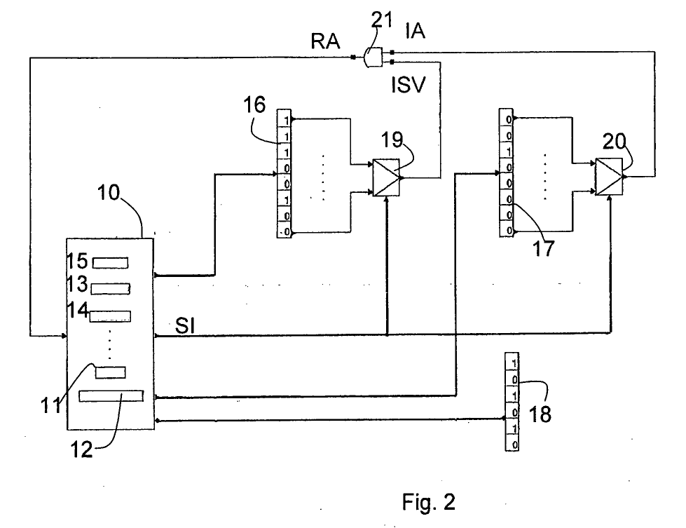

Referring next to FIG. 2, a schematic circuit diagram of the part of the circuit of the microcontroller device designed for controlling the interruption of iterative processing procedures is illustrated.

For this purpose, associated to the control unit 10 are three registers for storage of the information that describe the interrupt in course, namely:

a register of interrupts served, designated by the reference number 16, in which the interrupt served is stored;

a register, designated by the reference 17 and having a size corresponding to that of the register of the interrupts served 16, containing the information regarding which interrupt has interrupted execution of the iterative processing procedure; and

a register designated by the reference number 18, in which the state of the control unit 10 at which the interruption has taken place is stored, said register having a size corresponding to the base 2 logarithm of the number of states present in the module 12 for managing the iterative processing procedure.

As may be noted in FIG. 2, the control unit 10 writes directly to said registers 16, 17 and 18 and moreover sends a selection signal SI, which contains the information on the interrupt served.

The register 16 comprises, connected to its output, a multiplexer 19, controlled by said selection signal SI, which also controls the operation of a corresponding multiplexer 20, connected to the output of the register 17.

The outputs of said multiplexers 19 and 20 consist of respective signals ISV and IA, which are sent at input to an AND logic gate 21. Said logic gate 21 supplies at an output a return selection signal RA, which is sent to the control unit 10.

The operation of the microcontroller device is the following.

Should there arrive, during execution of an iterative processing procedure in the control unit 10, signalling of an external or internal event, i.e., an interrupt, the control flow in the control unit 10 passes from the module for managing the iterative processing procedure 12 to the interrupt managing module 11, by means of the transition designated by P1 in FIG. 1. The control unit 10 thus sets the bit corresponding to the interrupt served that has occurred in the registers 16 and 17 and stores in the register 18 a code corresponding to the state STI in the managing module 12 on which the interruption has taken place.

At the end of execution of the routine that has caused the interrupt, the control is again returned to the interrupt controller 11 for execution of an instruction of a “return from interrupt” type (RETI).

The selection signal SI contains the information regarding the interrupt served and is therefore used for setting the multiplexers 19 and 20, so that they select the corresponding outputs of the registers 16 and 17.

The outputs of the multiplexers 19 and 20, i.e., the signals ISV and IA corresponding to the interrupt that has occurred, are sent to the logic gate 21 for generating the return selection signal RA, which indicates whether the control must return directly to the module for managing the iterative processing procedure 12 or else must pass first to the arbiter module 15.

In fact, if the return selection signal RA assumes the logic value “1”, this means that the served interrupt from the interrupt routine of which the control is returning is the same one that has interrupted the iterative processing procedure. Consequently, the control can return to the module for managing the iterative processing procedure 12, by means of a transition designated by P2.

In this case, contained in the register 18 is the information regarding the state STI in the finite state machine that implements the control module 12 to which it is necessary to return in order to continue processing.

If the return selection signal RA assumes the logic value “0”, this means that the interrupt from which the control is returning has operated on a standard instruction and hence the control must pass to the arbiter module 15 by means of a transition designated by P3.

The solution just described enables considerable advantages to be achieved, as compared to known solutions.

The microcontroller device proposed advantageously enables management of interrupts that intervene on complex processing procedures, in particular iterative procedures implemented in a hardware manner using a finite state machine.

In addition, the interrupts can intervene at any state assumed by the finite state machine.

Advantageously, the control passes directly from the finite state machine that executes the complex processing procedure to the finite state machine that manages the interrupts and vice versa, without involving the arbiter module.

This solution increases the flexibility of the microcontroller device, thus enabling a higher speed in the execution of high-priority routines.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

Of course, without prejudice to the principle of the invention, the details of implementation and the embodiments may vary widely with respect to what is described and illustrated herein, without thereby departing from the scope of the present invention, as defined in the annexed claims.

1. A microcontroller device, comprising:
a control unit, the control unit having a plurality of logic modules including a processing module for executing processing procedures; an interrupt managing module for managing program interruptions caused by internal or external events; and an arbiter module for managing switching of said plurality of modules; and
a set of interruption registers associated with said control unit for storing information regarding interrupts and for requesting arrest of said processing module for executing processing procedures.

2. The microcontroller device of claim 1, wherein said set of interruption registers comprises:
a register of the served interrupts;
a register containing the information regarding which interrupt has interrupted execution of the processing procedure; and
a register in which there is stored the state of the module for managing the processing procedure at which said interrupt has occurred.

3. The microcontroller device of claim 2, wherein the control unit writes said information directly in said interrupt registers and sends a selection signal containing an information on the interrupt served.

4. The microcontroller device of claim 3, wherein downstream of the register of the served interrupts and of the register containing the information regarding which interrupt has interrupted execution of the processing procedure, there are provided respective multiplexers driven by said selection signal, and in that the outputs of said multiplexers are sent at input to a logic gate to obtain a return selection signal.

5. The microcontroller device of claim 1, wherein said plurality of logic modules comprises finite state machines.

6. The microcontroller device of claim 1, wherein said processing module is configured for executing iterative processing procedures.

7. A method for managing the program interrupts in a microcontroller device, which provides for the using of a module for managing the executive processing procedure of a control unit belonging to said microcontroller device for executing processing procedures and provides for managing interrupts by means of an interrupt managing module, the method comprising the following operations:
upon occurrence of an interrupt in a state of the processing procedure, transferring the control from the module for managing the executive processing procedure to the interrupt managing module;
storing the information regarding the interrupt that has occurred in interrupt registers;
at the end of the interrupt, transferring control to the interrupt managing module for execution of an instruction of a “return from interrupt” type; and
restoring the control to the module for managing the processing procedure at the state in which the interrupt occurred.

8. The method of claim 7, including the operations of:
evaluating whether the interrupt has occurred at a standard instruction; and
in the negative, restoring the control to the module for managing the processing procedure at the state where the interruption occurred; and
in the positive, restoring the control to an arbiter module.

9. The method of claim 8, wherein said operations of restoring the control to an arbiter module take place under the control of a return selection signal obtained from the information regarding the interrupt that has occurred stored in the interrupt registers.

10. The method of claim 7, wherein the information regarding the interrupt that has occurred and which is stored in the interrupt registers comprises information regarding the interrupt served, information regarding the interrupt that has occurred during the processing procedure, and the state of the processing procedure in which the interrupt that has occurred.

11. The method of claim 7, comprising the operation of configuring said processing module for execution of iterative processing procedures.

12. A computer program product directly loadable in the memory of a computer and comprising software code portions that perform the method of claim 7.

13. A microcontroller device, comprising:
a control unit comprising a processing module and an interrupt managing module;
a first register having an input coupled to the control unit, the first register configured to store interrupts;
a second register having an input coupled to the control unit and configured to store information regarding an interrupt that has interrupted execution of a processing procedure;
a third register having an input coupled to the control unit configured to store the state of the processing module at the time the interrupt occurs; and and
a logic gate having a first input coupled to the first register and a second input coupled to the second register and an output coupled to the control module.

14. The device of claim 13, further comprising a first multiplexer coupled between the first register and the first input of the logic gate and a second multiplexer coupled between the second register and the second input of the logic gate, the first and second multiplexers each having an input coupled to a selection signal output of the control unit.

15. The device of claim 14, wherein the processing module is configured to execute processing procedures, and the interrupt managing module is configured to manage program interruptions caused by internal and external events; and wherein the control unit further comprises an arbiter module for managing switching of the processing module and the interrupt managing module.

16. The device of claim 15, wherein the control unit is configured to write information directly in the first, second, and third registers.

17. The device of claim 16, wherein the processing module, the interrupt managing module, and the arbiter module each comprise finite state machines.

18. A method for managing program interrupts in a microcontroller device having a control unit that includes a processing module, an interrupt managing module, and an arbiter module, the device further including a set of interruption registers for storing information regarding interrupts and for requesting arrest of the processing module for executing processing procedures, the control unit configured to write information directly to the interrupt registers and to send a selection signal containing information regarding an interrupt, the method comprising:
receiving an interrupt in the control unit;
upon receipt of the interrupt, transferring control from the processing module to the interrupt managing module;
storing information regarding the interrupt into the set of interruption registers;
processing the interrupt; and
transferring control of the interrupt managing module at the end of the interrupt to the processing module at the state at which the interrupt occurred.

19. The method of claim 18, wherein receiving the interrupt comprises evaluating whether the interrupt has occurred at a standard instruction, and in the negative restoring the control to the processing module at the state where the interrupt occurred, and in the negative restoring control to the arbiter module.

20. The method of claim 19, wherein transferring control to the arbiter module comprises generating a return selection signal in response to information stored in the set of interrupt registers.

21. A microcontroller device, comprising:
a control unit that comprises a processing module for executing processing procedures having an output, an interrupt managing module having an input coupled to the output of the processing module, the interrupt managing module configured to manage program interruptions caused by one of at least internal and external events;
a loading manager module for managing loading of data into the control unit, and an arithmetic-operations manager module for managing arithmetic operations, the arbiter module configured to execute the operation of downloading instructions from a memory;
a first register having an input coupled to an output of the control unit, the first register configured to store interrupts;
a first multiplexer coupled to an output of the first register and having an output, the first multiplexer further having a control terminal coupled to a control output of the control unit;
a second register having an input coupled to an output of the control unit, the second register configured to store information regarding an interrupt that has interrupted execution of a processing procedure managed by the processing module;
a second multiplexer coupled to the second register and having an output, the second multiplexer further including a control terminal coupled to the control signal output of the control unit;
a third register having an input coupled to an output of the control unit, the third register configured to store the state of the processing module at the time the interrupt occurs; and
a logic gate having a first input coupled to the output of the first multiplexer, a second input coupled to the output of the second multiplexer, and an output coupled to an input of the control unit, the logic gate configured to generate a return selection signal, the processing module configured to transfer control to the interrupt managing module upon receipt of an interrupt signal, the control unit configured to write information directly to the first, second, and third registers regarding the interrupt, and upon receipt of a predetermined return selection signal, to transfer control to the interrupt managing module for execution of an instruction of a return-from-interrupt type that restores control to the processing module at the state at which the processing module was in at the time the interrupt occurred.
